(19) United States
(12) Patent Application Publication
(10) Pub. No.: US 2025/0166911 A1
(43) Pub. Date: May 22, 2025

(54) MULTILAYER ELECTRONIC COMPONENT

(71) Applicant: SAMSUNG ELECTRO-MECHANICS CO., LTD., Suwon-si (KR)

(72) Inventors: Jae Eun HEO, Suwon-si (KR); Hyung Jong CHOI, Suwon-si (KR); Chae Won BAK, Suwon-si (KR); Chung Eun LEE, Suwon-si, Gyeonggi-do (KR); Sang Hyeon LEE, Suwon-si (KR); Yong Min KIM, Suwon-si (KR)

(73) Assignee: SAMSUNG ELECTRO-MECHANICS CO., LTD., Suwon-si (KR)

(21) Appl. No.: 18/942,724

(22) Filed: Nov. 10, 2024

(30) Foreign Application Priority Data
Nov. 20, 2023 (KR) 10-2023-0161418

(51) Int. Cl. H01G 4/224; H01G 4/012; H01G 4/30

(52) U.S. Cl. CPC H01G 4/224; H01G 4/012; H01G 4/30

(57) ABSTRACT

A multilayer electronic component may include: a body including dielectric layers and having first and second surfaces opposing each other in a first direction, third and fourth surfaces opposing each other, and fifth and sixth surfaces opposing each other; first and second side margin portions disposed on the fifth and sixth surfaces, respectively; and first and second external electrodes disposed on the third and fourth surfaces, respectively. The body may include an active portion including an internal electrode alternately disposed with the dielectric layer, upper and lower cover portions disposed above and below the active portion in the first direction, respectively. One of the first and second side margin portions may include an inner margin portion covering at least a portion of the active portion, and an outer margin portion disposed on the inner margin portion and being in contact with the upper and lower cover portions.

### CROSS-REFERENCE TO RELATED APPLICATION(S)

This application claims benefit of priority to Korean Patent Application No. 10-2023-0161418 filed on Nov. 20, 2023 in the Korean Intellectual Property Office, the disclosure of which is incorporated herein by reference in its entirety.

### TECHNICAL FIELD

The present disclosure relates to a multilayer electronic component.

A multilayer ceramic capacitor (MLCC), a multilayer electronic component, may be a chip-type condenser mounted on the printed circuit boards of any of various electronic products, such as an imaging device, including a liquid crystal display (LCD) or a plasma display panel (PDP), a computer, a smartphone, or a mobile phone, serving to charge or discharge electricity therein or therefrom.

Such a multilayer ceramic capacitor has a small size, implements high capacitance, and is easily mounted on a circuit board, and may thus be used as a component of various electronic devices. There has been increasing demand for a multilayer ceramic capacitor to have a smaller size and higher capacitance as various electronic devices such as a computer and a mobile device have a smaller size and higher output.

In addition, as interest in electronic components for automobiles has recently increased, a multilayer ceramic capacitor requires high reliability and high strength characteristics to be used in automobiles or infotainment systems.

In order to implement miniaturization and high capacitance in a multilayer ceramic capacitor, maximization of an electrode effective area (an increase in an effective volume fraction required to realize capacitance) is required.

In order to achieve a small-sized and high capacitance multilayer ceramic capacitor as described above, in manufacturing the multilayer ceramic capacitor, by exposing an internal electrode in a width direction of a body, an area of the internal electrode in the width direction is maximized through a marginless design, and a side margin portion is separately attached to an exposed surface of the electrode in the width direction of a chip in an operation before sintering after manufacturing such a chip to complete the multilayer ceramic capacitor.

However, due to foreign substances present on a surface of the cut body and a difference in contraction rates between the body and the side margin portion during a plasticizing and/or sintering operation, the side margin may not be properly bonded to the body, which could cause a problem in which a gap between the side margin portion and the body widens.

### SUMMARY

An aspect of the present disclosure is to improve reliability of a multilayer electronic component.

An aspect of the present disclosure is to solve a problem in which a gap between a side margin portion and a body widens.

However, the purpose of the present disclosure is not limited to the above-described content, and may be more easily understood in the process of explaining specific embodiments of the present disclosure.

According to an aspect of the present disclosure, a multilayer electronic component may include: a body including a plurality of dielectric layers, the body having first and second surfaces opposing each other in a first direction, third and fourth surfaces connected to the first and second surfaces and opposing each other in a second direction, and fifth and sixth surfaces connected to the first to fourth surfaces and opposing each other in a third direction; first and second side margin portions disposed on the fifth and sixth surfaces, respectively; and first and second external electrodes disposed on the third and fourth surfaces, respectively. The body may include an active portion including an internal electrode alternately disposed with the dielectric layer in the first direction, an upper cover portion disposed above the active portion in the first direction, and a lower cover portion disposed below the active portion in the first direction, and one of the first and second side margin portions may include an inner margin portion covering at least a portion of the active portion on the fifth or sixth surface, and an outer margin portion disposed on the inner margin portion and disposed to be in contact with the upper cover portion and the lower cover portion.

### BRIEF DESCRIPTION OF DRAWINGS

The above and other aspects, features, and advantages of the present disclosure will be more clearly understood from the following detailed description, taken in conjunction with the accompanying drawings.

FIG. 1 schematically illustrates a perspective view of a multilayer electronic component according to an embodiment of the present disclosure.

FIG. 2 is a perspective view of the multilayer electronic component of FIG. 1 excluding an external electrode.

FIG. 3 is a perspective view illustrating the multilayer electronic component of FIG. 1 excluding an external electrode and a side margin portion.

FIG. 4 is a cross-sectional view taken along line I-I′ of FIG. 1.

FIG. 5 is a cross-sectional view taken along line II-II′ of FIG. 1.

FIG. 6 is an enlarged view of area K1 in FIG. 5.

FIG. 7 is an enlarged view of area K2 in FIG. 5.

FIG. 8 is a diagram corresponding to FIG. 7 according to another embodiment.

FIG. 9 is a diagram corresponding to FIG. 7 according to another embodiment.

FIGS. 10 and 11 are diagrams for illustrating a method of manufacturing a multilayer electronic component according to an embodiment of the present disclosure, FIG. 10 illustrates before attaching a side margin portion, and FIG. 11 illustrates after attaching a side margin portion.

### DETAILED DESCRIPTION

Hereinafter, embodiments of the present disclosure will be described as follows with reference to the attached drawings. The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art. Accordingly, shapes and sizes of elements in the drawings may be exaggerated for clear description, and elements indicated by the same reference numerals are the same elements in the drawings.

In the drawings, irrelevant descriptions will be omitted to clearly describe the present disclosure, and to clearly express a plurality of layers and areas, thicknesses may be magnified. The same elements having the same function within the scope of the same concept will be described with use of the same reference numerals. Throughout the specification, when a component is referred to as “comprise” or “comprising,” it means that it may further include other components as well, rather than excluding other components, unless specifically stated otherwise.

In the drawings, a first direction may refer to a stacking direction or a thickness (T) direction, a second direction may refer to a length (L) direction, and a third direction may refer to a width (W) direction.

### Multilayer Electronic Component

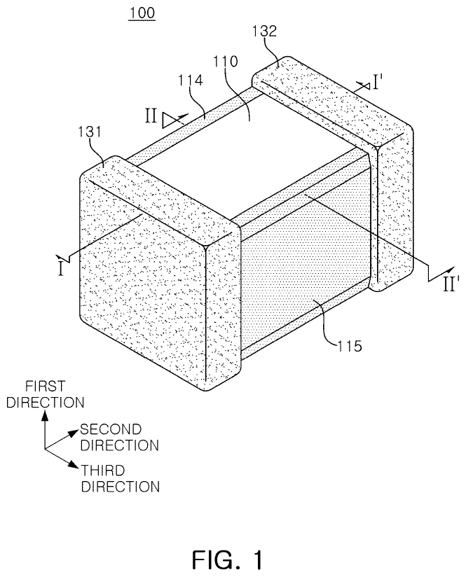

FIG. 1 schematically illustrates a perspective view of a multilayer electronic component according to an embodiment of the present disclosure.

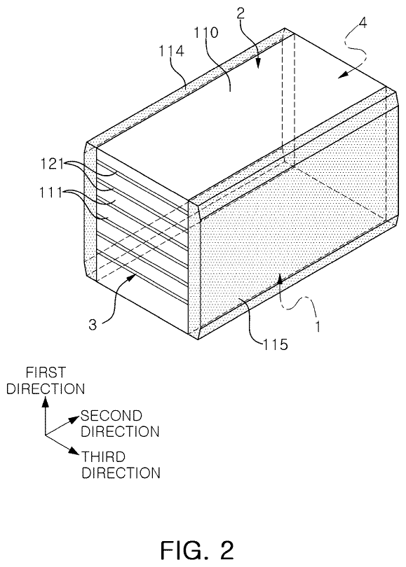

FIG. 2 is a perspective view of the multilayer electronic component of FIG. 1 excluding an external electrode.

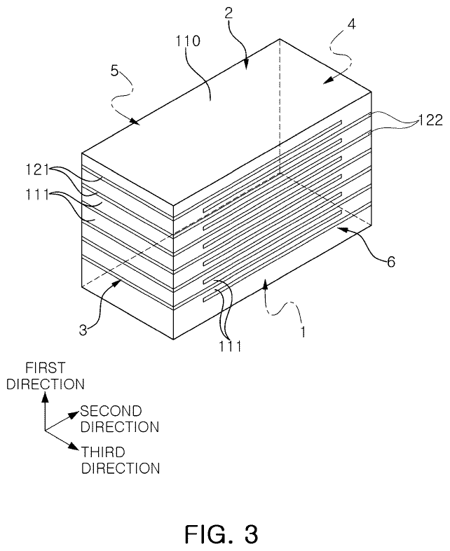

FIG. 3 is a perspective view illustrating the multilayer electronic component of FIG. 1 excluding an external electrode and a side margin portion.

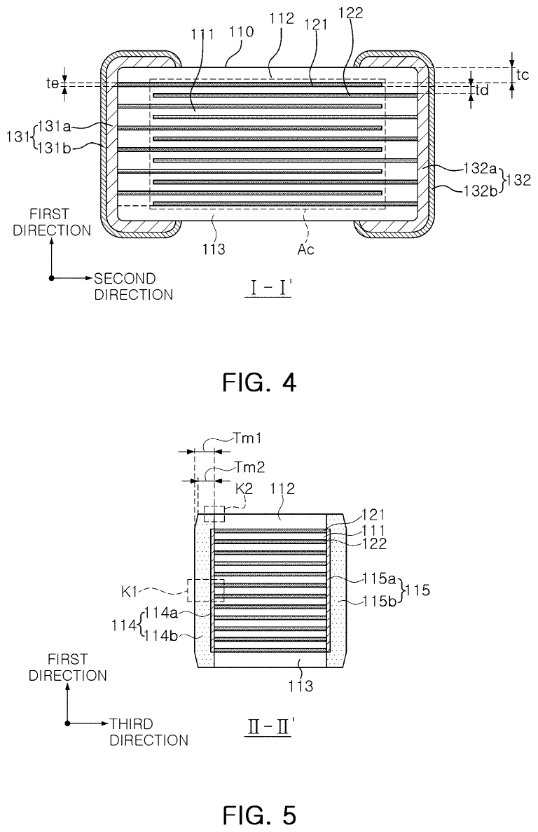

FIG. 4 is a cross-sectional view taken along line I-I′ of FIG. 1.

FIG. 5 is a cross-sectional view taken along line II-II′ of FIG. 1.

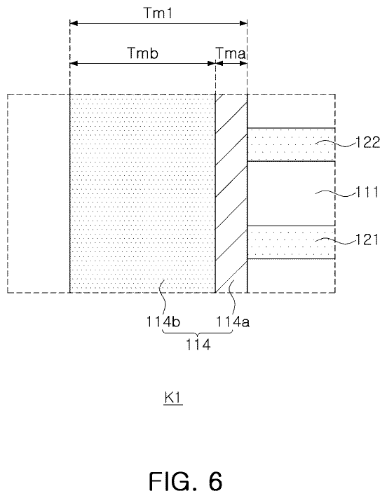

FIG. 6 is an enlarged view of area K1 in FIG. 5.

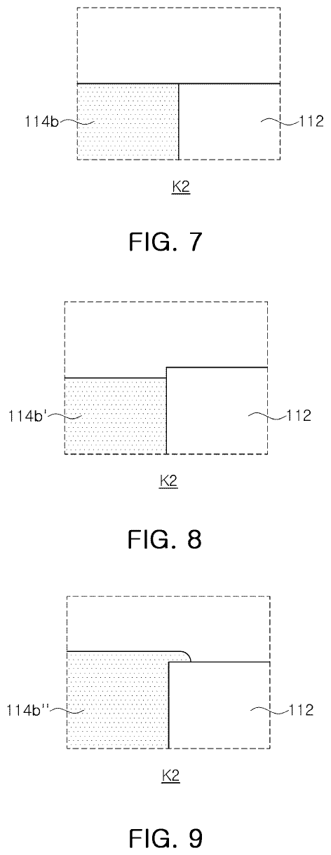

FIG. 7 is an enlarged view of area K2 in FIG. 5.

Hereinafter, a multilayer electronic component according to an embodiment of the present disclosure will be described in detail, with reference to FIGS. 1 to 7.

According to an embodiment of the present disclosure, a multilayer electronic component 100 may include: a body 110 including a plurality of dielectric layers 111, the body having first and second surfaces 1 and 2 opposing each other in a first direction, third and fourth surfaces 3 and 4 connected to the first and second surfaces 1 and 2 and opposing each other in a second direction, and fifth and sixth surfaces 5 and 6 connected to the first to fourth surfaces 1 to 4 and opposing each other in a third direction; side margin portions 114 and 115 disposed on the fifth and sixth surfaces 5 and 6; and external electrodes 131 and 132 disposed on the third and fourth surfaces 3 and 4. The body may include an active portion Ac including internal electrodes 121 and 122 alternately disposed with the dielectric layer 111 in the first direction, an upper cover portion 112 disposed above the active portion Ac in the first direction, and a lower cover portion 113 disposed below the active portion Ac in the first direction, and the side margin portion may include inner margin portions 114a and 115a covering at least a portion of the active portion Ac on the fifth and sixth surfaces 5 and 6, and outer margin portions 114b and 115b disposed on the inner margin portions 114a and 115a and disposed to be in contact with the upper cover portion 112 and the lower cover portion 113.

In order to achieve a small-sized and high-capacitance multilayer ceramic capacitor, in manufacturing the multilayer ceramic capacitor, by exposing an internal electrode in a width direction of a body, an area of the internal electrode in the width direction is maximized through a marginless design, and a side margin portion is separately attached to an exposed surface of the electrode in the width direction of a chip in an operation before sintering after manufacturing such a chip to complete the multilayer ceramic capacitor.

However, due to foreign substances present on a surface of the cut body and a difference in contraction rates between the body and the side margin portion during a plasticizing and/or sintering operation, the side margin portion may not be properly bonded to the body, which could cause a problem in which a gap between the side margin portion and the body widens.

According to an embodiment of the present disclosure, as the side margin portions 114 and 115 include inner margin portions 114a and 115a covering at least a portion of the active portion Ac on the fifth and sixth surfaces 5 and 6 and outer margin portions 114b and 115b disposed on the inner margin portions 114a and 115a and disposed to be in contact with the upper cover portion 112 and the lower cover portion 113, the bonding force between the side margin portion and the body may be improved so that it is possible to suppress that a problem in which a gap between the side margin portion and the body widens.

Hereinafter, each component included in the multilayer electronic component 100 according to an embodiment of the present disclosure will be described.

The body 110 has a dielectric layer 111 and internal electrodes 121 and 122, alternately stacked therein.

The body 110 is not limited to a particular shape, and may have a hexahedral shape or a shape similar to the hexahedral shape, as illustrated in the drawings. The body 110 may not have a hexahedral shape having perfectly straight lines because ceramic powder particles included in the body 110 are contracted in a process in which the body is sintered. However, the body 110 may have a substantially hexahedral shape.

The body 110 may have first and second surfaces 1 and 2 opposing each other in a first direction, third and fourth surfaces 3 and 4 connected to the first and second surfaces 1 and 2 and opposing each other in a second direction, and fifth and sixth surfaces 5 and 6 connected to the first and second surfaces 1 and 2, connected to the third and fourth surfaces 3 and 4, and opposing each other in a third direction.

A plurality of dielectric layers 111 forming the body 110 may be in a sintered state, and adjacent dielectric layers 111 may be integrated with each other, such that boundaries therebetween may not be readily apparent without a scanning electron microscope (SEM).

According to an embodiment of the present disclosure, a raw material for forming the dielectric layer 111 is not particularly limited, as long as sufficient electrostatic capacitance may be obtained therewith. For example, the raw material for forming the dielectric layer 111 may be a barium titanate (BaTiO₃)-based material, a lead composite perovskite-based material, a strontium titanate (SrTiO₃)-based material, or the like. The barium titanate-based material may include BaTiO₃-based ceramic powder, and the ceramic powder may be, for example, BaTiO₃, (Ba₁₋ₓCaₓ) TiO₃, Ba (Ti_{1-y}Ca_{y})O₃, (Ba₁₋ₓCaₓ) (Ti_{1-y}Zr_{y})O₃ or Ba (Ti_{1-y}Zr_{y}) O₃, in which calcium (Ca), zirconium (Zr), or the like, are partially dissolved in BaTiO₃, and the like.

A material for forming the dielectric layer 111 may include various ceramic additives, organic solvents, binders, dispersants, and the like, added to powder particles such as barium titanate (BaTiO₃) powder particles, or the like, according to an object of the present disclosure.

The internal electrodes 121 and 122 may be arranged disposed with the dielectric layer 111.

The internal electrodes 121 and 122 may include first and second internal electrodes 121 and 122. The first and second internal electrodes 121 and 122 may be alternately disposed to oppose each other with the dielectric layer 111 forming the body 110 interposed therebetween, and may be exposed to the third and fourth surfaces 3 and 4 of the body 110, respectively.

In an embodiment, the internal electrodes 121 and 122 may include first and second internal electrodes 121 and 122 alternately disposed in the first direction with a dielectric layer 111 interposed therebetween, and the first internal electrode 121 may be connected to the third, fifth, and sixth surfaces 3, 5, and 6, and the second internal electrode 122 may be connected to the fourth, fifth, and sixth surfaces 4, 5, and 6.

Referring to FIG. 3, the first internal electrode 121 may be spaced apart from the fourth surface 4 and exposed through the third surface 3, and the second internal electrode 122 may be spaced apart from the third surface 3, and exposed through the fourth surface 4. In addition, the first internal electrode 121 may be exposed through the third, fifth, and sixth surfaces 3, 5, and 6, and the second internal electrode 122 may be exposed through the fourth, fifth, and sixth surfaces 4, 5, and 6.

In this case, the first and second internal electrodes 121 and 122 may be electrically isolated from each other by a dielectric layer 111 disposed in the middle.

The internal electrodes 121 and 122 may include at least one of nickel (Ni), copper (Cu), palladium (Pd), silver (Ag), gold (Au), platinum (Pt), tin (Sn), tungsten (W), and titanium (Ti) and alloys thereof.

An average thickness “td” of the dielectric layer 111 is not particularly limited, but for example, the average thickness “td” of the dielectric layer 111 may be 0.1 to 10 μm. An average thickness “te” of the internal electrodes 121 and 122 is not particularly limited, but, may be, for example, 0.4 μm to 2.0 μm. In addition, the average thickness “td” of the dielectric layer 111 and the average thickness “te” of the internal electrodes 121 and 122 may be arbitrarily set according to desired characteristics or purposes. For example, in the case of small IT electronic components, in order to achieve miniaturization and high capacitance, the average thickness “td” of the dielectric layer 111 may be 0.5 μm or less, and the average thickness “te” of the internal electrodes 121 and 122 may be 0.5 μm or less.

The average thickness “td” of the dielectric layer 111 and the average thickness “te” of the internal electrodes 121 and 122 may mean a size of the dielectric layer 111 and the internal electrodes 121 and 122 in the first direction, respectively. The average thickness “td” of the dielectric layer 111 and the average thickness “te” of the internal electrodes 121 and 122 may be measured by scanning a cross-section of the body 110 in the first and second directions with a scanning electron microscope (SEM) at a magnification of 10,000. More specifically, an average value may be measured by measuring a thickness of one dielectric layer 111 at multiple points, for example, at 30 points at equally spaced intervals in the second direction. The 30 points at equally spaced intervals may be designated in an active portion Ac. Meanwhile, if the average value is measured by extending the average value measurement to 10 dielectric layers 111 and 10 internal electrodes 121 and 122, the average thickness “td” of the dielectric layer 111 and the average thickness “te” of the internal electrodes 121 and 122 can be more generalized.

The body 110 may include an active portion Ac disposed in the body 110, and including a first internal electrode 121 and a second internal electrode 122 disposed to oppose each other with the dielectric layer 111 interposed therebetween and having capacitance formed therein, and cover portions 112 and 113 formed above and below the active portion Ac in the first direction.

In addition, the active portion Ac is a portion serving to contribute to capacitance formation of a capacitor, and may be formed by repeatedly stacking a plurality of first and second internal electrodes 121 and 122 with a dielectric layer 111 interposed therebetween.

The upper cover portion 112 and the lower cover portion 113 may be formed by stacking a single dielectric layer or two or more dielectric layers on upper and lower surfaces of the active portion Ac in a thickness direction, respectively, and the upper cover portion 112 and the lower cover portion 113 may serve to basically prevent damage to the internal electrodes due to physical or chemical stress.

The upper cover portion 112 and the lower cover portion 113 may not include internal electrodes, and may include the same material as that of the dielectric layer 111.

That is, the upper cover portion 112 and the lower cover portion 113 may include a ceramic material, for example, a barium titanate (BaTiO₃)-based ceramic material.

Meanwhile, a thickness of the cover portions 112 and 113 is not particularly limited. However, in order to more easily achieve miniaturization and high capacitance of a multilayer electronic component, a thickness “tc” of the cover portions 112 and 113 may be 30 μm or less.

The average thickness “tc” of the cover portions 112 and 113 may mean a size thereof in the first direction, and may be a value obtained by averaging sizes of the cover portions 112 and 113 in the first direction measured at five points having equal intervals above or below the active portion Ac.

In addition, side margin portions 114 and 115 may be disposed on a side surface of the active portion Ac.

The side margin portions 114 and 115 may include a first side margin portion 114 disposed on the fifth surface 5 of the body 110 and a second side margin portion 115 disposed on the sixth surface 6 thereof. That is, the side margin portions 114 and 115 may be disposed on both end surfaces of the body 110 in a third direction.

The side margin portions 114 and 115 may basically serve to prevent damage to the internal electrodes due to physical or chemical stresses.

The side margin portions 114 and 115 may include inner margin portions 114a and 115a covering at least a portion of the active portion Ac on the fifth and sixth surfaces, and outer margin portions 114b and 115b disposed on the inner margin portions and disposed to contact the upper cover portion 112 and the lower cover portion 113. Accordingly, bonding force between the side margin portions 114 and 115 and the body 110 may be improved to prevent a gap between the side margin portions 114 and 115 and the body 110 from widening.

Since the fifth and sixth sides of the body 110 include an active portion Ac and cover portions 112 and 113, and the active portion Ac includes not only a dielectric layer 111 but also internal electrodes 121 and 122, when forming a side margin portion by attaching only one type of sheet as in the prior art, it was difficult to simultaneously improve coupling force between the side margin portions, the active portion Ac, and the cover portions 112 and 113. On the other hand, in the present disclosure, since the inner margin portions 114a and 115a serve to increase coupling force between the side margin portions 114 and 115 and the active portion Ac, and the outer margin portions 114b and 115b serve to increase coupling force between the side margin portions 114 and 115 and the cover portions 112 and 113, so that coupling force between the side margin portions 114 and 115, the active portion Ac, and the cover portions 112 and 113 may be simultaneously improved.

In an embodiment, the outer margin portions 114b and 115b may be disposed to cover upper ends and lower ends of the inner margin portions 114a and 115a in a first direction. Accordingly, a region of the outer margin portions 114b and 115b, covering the upper ends and lower ends of the inner margin portions 114a and 115a in the first direction, may have a step.

In an embodiment, the inner margin portions 114a and 115a may be disposed to completely cover the active portion Ac on the fifth and sixth surfaces. Accordingly, a contact area between the inner margin portions 114a and 115a and the active portion may be increased to further improve the bonding force between the side margin portions 114 and 115 and the body 110.

However, there is no need to limit the inner margin portions 114a and 115a to covering only the active portion Ac, and in an embodiment, the upper ends of the inner margin portions 114a and 115a in the first direction may contact the upper cover portion 112 on the fifth and sixth surfaces, and the lower ends of the inner margin portions 114a and 115a in the first direction may contact the lower cover portion 113 on the fifth and sixth surfaces.

In an embodiment, a region of the outer margin portions 114b and 115b, covering the upper ends and lower ends of the inner margin portions 114a and 115a in the first direction may have a step. This is because, since the outer margin portions 114b and 115b cover the inner margin portions 114a and 115a, a width of the side margin portion in a third direction is reduced accordingly in a region in which the inner margin portions 114a and 115a are not disposed.

In an embodiment, the outer margin portions 114b and 115b may be disposed to completely cover the inner margin portions 114a and 115a. That is, the outer margin portions 114b and 115b may be disposed to cover not only both ends of the inner margin portions 114a and 115a in the first direction, but also both ends of the inner margin portions 114a and 115a in the second direction, to completely cover the inner margins 114a and 115a.

Referring to FIG. 7, the upper ends of the outer margin portions 114b and 115b in the first direction may be disposed on the same plane as the second surface, and the lower ends of the outer margin portions in the first direction may be disposed on the same plane as the first surface.

However, considering manufacturing errors, or the like, in the side margin portion, it does not necessarily have to have this shape.

For example, according to another embodiment of the present disclosure, as illustrated in FIG. 8, an upper ends of an outer margin portion 114b′ in a first direction may be disposed in a lower portion thereof in the first direction than the second surface, and a lower end of the outer margin portion 114b′ in the first direction may be disposed in an upper portion thereof in the first direction than the first surface. In this case, the upper end of the outer margin portions 114b′ in the first direction may be in contact with the upper cover portion 112 on the fifth surface 5, and the lower end of the outer margin portion 114b′ in the first direction may be in contact with the lower cover portion 113 on the fifth surface 5. The outer margin portion on the sixth surface 6 may be configured similarly, and a corresponding description will be omitted to avoid redundancy.

In addition, according to another embodiment of the present disclosure, as illustrated in FIG. 9, an upper end of an outer margin portion 114b″ in a first direction may be disposed above the second surface 2 in the first direction, and a lower end of the outer margin portion 114b″ in the first direction may be disposed below the first surface 1 in the first direction. In this case, at least a portion of the outer margin portion 114b″ may be disposed on the first and second surfaces 1 and 2. The outer margin portion disposed mainly on the sixth surface 6 may be configured similarly, and a corresponding description will be omitted to avoid redundancy.

In an embodiment, an average width “Tma” of the inner margin portions 114a and 115a in a third direction may be 0.5 μm or more and 5 μm or less. When the average width “Tma” is less than 0.5 μm, it may be difficult to stably form the inner margin portions 114a and 115a, and when the average width “Tma” exceeds 5 μm, there is a concern that the outer margin portions 114b and 115b may not be properly bonded due to the increased step caused by the inner margin portions 114a and 115a.

In an embodiment, an average width “Tmb” of the outer margin portions 114b and 115b in a third direction may be 15 μm or more and 40 μm or less. When the average width “Tmb” is less than 15 μm, capacitance per unit volume may be reduced or reliability may be reduced due to external impacts, moisture infiltration, and the like, and when the average width “Tmb” exceeds 40 μm, there is a risk that the capacitance per unit volume may be reduced.

In an embodiment, when the average width of the inner margin portions 114a and 115a in the third direction is Tma, and the average width of the outer margin portions 114b and 115b in the third direction is Tmb, Tmb/Tma may be 3 or more and 80 or less. Accordingly, the effect of securing reliability while improving coupling force between the side margin portions 114 and 115 and the body 110 can be further improved.

In an embodiment, a width of the side margin portions 114 and 115 in a third direction in a center thereof in the first direction is Tm1 and a width of the side margin portions 114 and 115 in a third direction at an upper end thereof in the first direction is Tm2, Tm1-Tm2 may be 0.5 μm or more and 5 μm or less. This is because the inner margin portions 114a and 115a are not disposed at the upper ends of the side margin portions 114 and 115 in the first direction, so the width may be reduced by the width of the inner margin portions 114a and 115a.

Meanwhile, the width of the side margin portions 114 and 115 in the third direction in a region in which the inner margin portions 114a and 115a are disposed may be substantially the same, and a width deviation may be within 5%. When described in more detail with reference to FIG. 5, the width of the side margin portions 114 and 115 in the third direction, measured from the outermost internal electrodes 121 and 122 may be substantially equal to the width of the side margin portions 114 and 115 in the third direction in the center thereof in the first direction and the width deviation may be within 5%.

The average widths Tma, Tmb, Tm1, and Tm2 may be measured from a cross-section of the body in the first and third directions taken from the center of the body 110 in the second direction, and the average widths Tma and Tmb may be a value obtained by averaging respective values measured at five points disposed at equal intervals on a side surface of the active portion Ac of the side margin portions 114 and 115.

In an embodiment, the inner margins 114a and 115a may have a different composition than the outer margins 114b and 115b. When the inner margin portions 114a and 115a and the outer margin portions 114b and 115b have the same composition, it may be difficult to simultaneously improve coupling force between the side margin portion, the active portion Ac, and the cover portions 112 and 113.

The inner margin portions 114a and 115a may have the same or similar composition to that of the dielectric layer of the active portion Ac to secure bonding force to the active portion Ac. In addition, a content of a binder included in a material for forming the inner margin portions 114a and 115a may be higher than a content of a binder included in a material for forming the outer margin portions 114b and 115b.

The outer margin portions 114b and 115b may have the same composition as the dielectric sheet for forming the cover portions 112 and 113. In addition, since the outer margin portions 114b and 115b are exposed to the outside, the outer margin portions 114b and 115b may include an additive to prevent external impacts, moisture infiltration, and the like.

In an embodiment, porosity of the inner margin portions 114a and 115a may be higher than porosity of the outer margin portions 114b and 115b. When the content of the binder included in the material for forming the inner margin portions 114a and 115a is set to be higher than the content of the binder included in the material for forming the outer margin portions 114b and 115b to secure bonding force to the active portion Ac, the binder may be removed during a firing and sintering process and pores may be formed in the place in which the binder was. Accordingly, the porosity of the inner margin portions 114a and 115a may be higher than the porosity of the outer margin portions 114b and 115b.

Meanwhile, a method of forming the side margin portions 114 and 115 is not particularly limited.

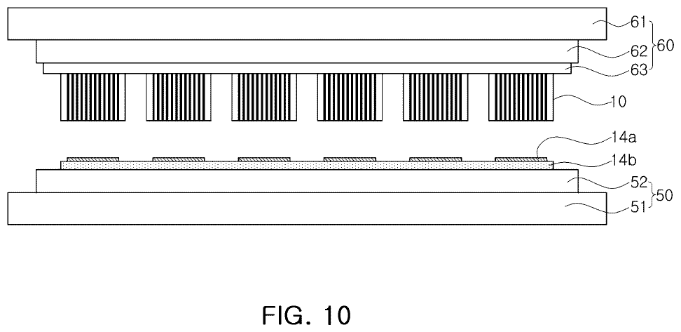

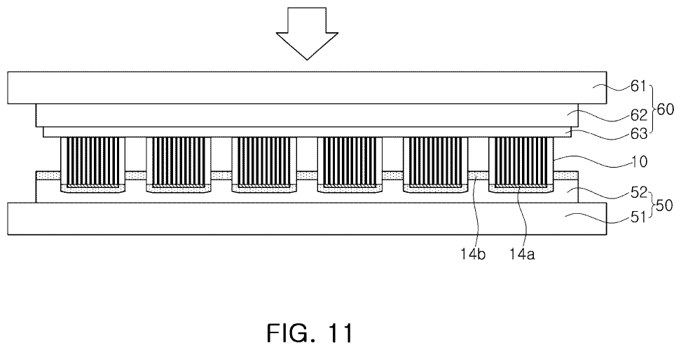

Referring to FIG. 10 as a preferred example, bodies 10 before sintering may be attached to an upper plate 60 to be spaced apart from each other, and a sheet 14b for forming the outer margin portions 114b and 115b and a sheet for forming the inner margin portions 114a and 115a may be disposed on the lower plate 50. The upper plate 60 may include upper supports 61 and 62 and an adhesive member 63, and the lower plate 50 may include a lower support 51 and an elastic member 52. The fifth or sixth surface of the body 10 before sintering may be attached by the adhesive member 63. In this case, the sheet 14a for forming the inner margin portions 114a and 115a may be disposed to be spaced apart on the sheet 14b for forming the outer margin portions 114b and 115b to be bonded only to the active portion, and may be manufactured to the same size as the size of the active portion on a surface of the body 10 before sintering to be attached.

Thereafter, when pressed as shown in FIG. 11, the sheet 14a for forming the inner margin portions 114a and 115a may be attached to the active portion by pressure, and a portion of the sheet 14b for forming the outer margin portions 114b and 115b may be cut. Thereafter, the same process may be performed on the surface of the body 10 before sintering attached to the adhesive member 63, and then the body 110 and the side margin portions 114 and 115 may be formed through the sintering process.

However, the present disclosure is not limited thereto, and the inner margin portions 114a and 115a may also be manufactured by applying a material for forming the inner margin portions 114a and 115a to the active portion of the body 10 before sintering.

External electrodes 131 and 132 may be disposed on the third and fourth surfaces 3 and 4 of the body 110.

The external electrodes 131 and 132 may include first and second external electrodes 131 and 132 respectively disposed on the third and fourth surfaces 3 and 4 of the body 110, and respectively connected to the first and second internal electrodes 121 and 122.

Referring to FIG. 1, the external electrodes 131 and 132 may be disposed to cover both end surfaces of the side margin portions 114 and 115 in the second direction.

In the present embodiment, a structure in which the multilayer electronic component 100 has two external electrodes 131 and 132 is described. However, the number and shape of the external electrodes 131 and 132 may be changed according to the shape of the internal electrodes 121 and 122 or other purposes.

In an embodiment, the external electrodes 131 and 132 may include a first external electrode 131 disposed on the third surface 3 of the body 110 and a second external electrode 132 disposed on the fourth surface 4 of the body 110. The first external electrode 131 may cover one end of the side margin portions 114 and 115 in the second direction, and the second external electrode 132 may cover the other end of the side margin portions 114 and 115 in the second direction.

In an embodiment, the internal electrodes 121 and 122 may include a first internal electrode 121 in contact with the first external electrode 131 and a second internal electrode 122 in contact with the second external electrode 132, and both ends of the first and second internal electrodes 121 and 122 in the third direction may contact the side margin portions 114 and 115.

Meanwhile, the external electrodes 131 and 132 may be formed using any material as long as it has electrical conductivity, such as metal, and a specific material may be determined by considering electrical characteristics, structural stability, and the like, and may have a multi-layer structure.

For example, the external electrodes 131 and 132 may include electrode layers 131a and 132a disposed on the body 110 and plating layers 131b and 132b formed on the electrode layers 131a and 132a.

For a more specific example of the electrode layers 131a and 132a, the electrode layers may be fired electrodes including a conductive metal and glass, or resin-based electrodes including a conductive metal and a resin.

In addition, the electrode layers 131a and 132a may be formed by sequentially forming a fired electrode and a resin-based electrode on a body. In addition, the electrode layers 131a and 132a may be formed by transferring a sheet including a conductive metal onto a body, or by transferring a sheet including a conductive metal onto a fired electrode.

As the conductive metal included in the electrode layers 131a and 132a, a material having excellent electrical conductivity can be used and is not particularly limited. For example, the conductive metal may include at least one selected from the group consisting of nickel (Ni), copper (Cu), palladium (Pd), silver (Ag), gold (Au), platinum (Pt), tin (Sn), tungsten (W), titanium (Ti) and alloys thereof.

The plating layers 131b and 132b serve to improve mounting characteristics. The type of the plating layers 131b and 132b is not particularly limited, and may be plating layers including at least one of Ni, Sn, Pd, and alloys thereof, and may be formed of a plurality of layers.

For a more specific example of the plating layers 131b and 132b, the plating layers 131b and 132b may be a Ni plating layer or a Sn plating layer, may have a form in which the Ni plating layer and the Sn plating layer are sequentially formed on the electrode layers 131a and 132a, and may have a form in which the Sn plating layer, the Ni plating layer, and the Sn plating layer are sequentially formed. In addition, the plating layers 131b and 132b may include a plurality of Ni plating layer and/or a plurality of Sn plating layers.

A size of the multilayer electronic component 100 does not need to be particularly limited.

However, to achieve both miniaturization and high capacitance, the number of laminated layers should be increased by thinning a dielectric layer and internal electrodes. A reliability improvement effect according to the present disclosure may become more remarkable in the multilayer electronic component 100 having a size of 1005 (length×width, 1.0 mm×0.5 mm) or less.

When the multilayer electronic component 100 has a length of 1.1 mm or less and a width of 0.55 mm or less in consideration of a manufacturing error and a size of an external electrode, an effect of improving reliability and capacitance per unit volume according to the present disclosure may be more remarkable. Here, the length of the multilayer electronic component 100 may refer to a maximum size of the multilayer electronic component 100 in the second direction, and the width of the multilayer electronic component 100 may refer to a maximum size of the multilayer electronic component 100 in the third direction.

As set forth above, as one of the many effects of the present disclosure, reliability of a multilayer electronic component may be improved.

As one of the many effects of the present disclosure, bonding force between a side margin portion and a body may be improved.

Although the embodiments of the present disclosure have been described in detail above, the present disclosure is not limited by the above-described embodiments and the accompanying drawings, and is intended to be limited by the appended claims. Therefore, various forms of substitution, modification, and change will be possible by those skilled in the art within the scope of the technical spirit of the present disclosure described in the claims, which also falls within the scope of the present disclosure.

In addition, the expression ‘one embodiment’ used in the present disclosure does not mean the same embodiment, and is provided to emphasize and describe different unique characteristics. However, one embodiment presented above is not excluded from being implemented in combination with features of another embodiment. For example, even if a matter described in one specific embodiment is not described in another embodiment, it can be understood as a description related to another embodiment, unless there is a description contradicting or contradicting the matter in the other embodiment.

Terms used in this disclosure are only used to describe one embodiment, and are not intended to limit the disclosure. In this case, singular expressions include plural expressions unless the context clearly indicates otherwise.

While example embodiments have been shown and described above, it will be apparent to those skilled in the art that modifications and variations could be made without departing from the scope of the present invention as defined by the appended claims.

What is claimed is:

1. A multilayer electronic component, comprising:
a body including a plurality of dielectric layers, the body having first and second surfaces opposing each other in a first direction, third and fourth surfaces connected to the first and second surfaces and opposing each other in a second direction, and fifth and sixth surfaces connected to the first to fourth surfaces and opposing each other in a third direction;
first and second side margin portions disposed on the fifth and sixth surfaces, respectively; and
first and second external electrodes disposed on the third and fourth surfaces, respectively,
wherein the body includes an active portion including an internal electrode alternately disposed with the dielectric layer in the first direction, an upper cover portion disposed above the active portion in the first direction, and a lower cover portion disposed below the active portion in the first direction, and
one of the first and second side margin portions includes an inner margin portion covering at least a portion of the active portion on the fifth or sixth surface, and an outer margin portion disposed on the inner margin portion and disposed to be in contact with the upper cover portion and the lower cover portion.

2. The multilayer electronic component of claim 1, wherein the outer margin portion is disposed to cover an upper end and a lower end of the inner margin portion in the first direction.

3. The multilayer electronic component of claim 1, wherein the inner margin portion is disposed to completely cover the active portion on the fifth or sixth surface.

4. The multilayer electronic component of claim 1, wherein the upper end of the inner margin portion in the first direction is in contact with the upper cover portion on the fifth or sixth surfaces, and the lower end of the inner margin portion in the first direction is in contact with the lower cover portion on the fifth or sixth surface.

5. The multilayer electronic component of claim 1, wherein a region of the outer margin portion, covering an upper end or a lower end of the inner margin portion in the first direction has a step.

6. The multilayer electronic component of claim 1, wherein in a first direction-third direction cross-section, the outer margin portion extends continuously to cover the inner margin portion.

7. The multilayer electronic component of claim 1, wherein an upper end of the outer margin portion in the first direction is disposed on the same plane as the second surface, and a lower end of the outer margin portion in the first direction is disposed on the same plane as the first surface.

8. The multilayer electronic component of claim 1, wherein an upper end of the outer margin portion in the first direction is disposed below the second surface in the first direction, and a lower end of the outer margin portion in the first direction is disposed above the first surface in the first direction.

9. The multilayer electronic component of claim 1, wherein an upper end of the outer margin portion in the first direction is in contact with the upper cover portion on the fifth or sixth surface, and a lower end of the outer margin portion in the first direction is in contact with the lower cover portion on the fifth or sixth surface.

10. The multilayer electronic component of claim 1, wherein an upper end of the outer margin portion in the first direction is disposed above the second surface in the first direction, and a lower end of the outer margin portion in the first direction is disposed below the first surface in the first direction.

11. The multilayer electronic component of claim 1, wherein at least a portion of the outer margin portion is disposed on the first and second surfaces.

12. The multilayer electronic component of claim 1, wherein an average width of the inner margin portion in the third direction is 0.5 μm or more and 5 μm or less.

13. The multilayer electronic component of claim 1, wherein an average width of the outer margin portion in the third direction is 15 μm or more and 40 μm or less.

14. The multilayer electronic component of claim 1, wherein, an average width of the inner margin portion in the third direction is Tma, an average width of the outer margin portion in the third direction is Tmb, and Tmb/Tma is 3 or more and 80 or less.

15. The multilayer electronic component of claim 1, wherein, an average width of the one of the first and second side margin portions in the third direction in a center of the one of the first and second side margin portions in the first direction is Tm1, an average width of the one of the first and second side margin portions in the third direction at an upper end of the one of the first and second side margin portions in the first direction is Tm2, and Tm1-Tm2 is 0.5 μm or more and 5 μm or less.

16. The multilayer electronic component of claim 1, wherein the inner margin portion has a different composition from the outer margin portion.

17. The multilayer electronic component of claim 1, wherein porosity of the inner margin portion is higher than porosity of the outer margin portion.

18. The multilayer electronic component of claim 1, wherein the internal electrode comprises first and second internal electrodes alternately disposed with the dielectric layer interposed therebetween in the first direction, and
the first internal electrode is connected to the third, fifth, and sixth surfaces, and the second internal electrode is connected to the fourth, fifth, and sixth surfaces.

19. The multilayer electronic component of claim 1, wherein the first external electrode covers one end of the one of the first and second side margin portions in the second direction, and the second external electrode covers the other end of the one of the first and second side margin portions in the second direction.

20. The multilayer electronic component of claim 1, wherein in a first direction-third direction cross-section, the inner margin portion continuously extends to cover the active portion on the fifth or sixth surface.
